(19) United States
(12) Patent Application Publication
(10) Pub. No.: US 2018/0096395 A1
(43) Pub. Date: Apr. 5, 2018

(54) Mobile Electronic Billboard

(71) Applicants: Jonah Douglas Friedl, Kirkland, WA (US); Conner Shawn Brennick, Kirkland, WA (US)

(72) Inventors: Jonah Douglas Friedl, Kirkland, WA (US); Conner Shawn Brennick, Kirkland, WA (US)

(21) Appl. No.: 15/285,477

(22) Filed: Oct. 4, 2016

(51) Int. Cl. G06Q 30/02

(52) U.S. Cl. CPC G06Q 30/0266

(57) ABSTRACT

A method includes mobile electronic billboards attached to human beings with no fixed location, connected to computer networks, By being attached to a human, the mobile billboard is able to be deployed and advertise in any location accessible by humans. Furthermore, with the mobile electronic billboards connected to networks, they can display any message that is contextual to time, location, weather conditions, and other contextual information. The owner of the message (the advertiser) has the ability to receive reports with statistics that include where their content was displayed, when it was displayed, who saw the content, and how many viewers saw it.

### CROSS-REFERENCE TO RELATED APPLICATIONS

This application claims priority to U.S. Provisional Patent Application Ser. No. 62/237,468, entitled “Mobile Electronic Billboard,” filed Oct. 5, 2015, which is incorporated herein by reference in its entirety.

### BACKGROUND OF THE INVENTION

The invention generally relates to “out-of-home” advertising, which is advertising located in the physical world such as billboards and posters, and more specifically to electronic versions of billboards, connected to a network, made mobile by being placed on human beings.

In general, out-of-home advertising, such as billboards (both physical and electronic), posters and banners, are used to convey a message to people who walk within the visual proximity of the out-of home advertisement. This message can be used for conveying a variety of messages, including but not limited to, commercial, social, political messages.

An out-of-home advertisement typically is provided by companies who own or lease the physical location where the billboard is located. Often the provider of the out-of-home advertisement billboard will charge a company or organization a fee to place their message on the billboard. Payment fees are based on estimates number of people who visually see the billboard over a certain time period, such as a month.

### SUMMARY OF THE INVENTION

The following presents a simplified summary of the innovation in order to provide a basic understanding of some aspects of the invention. This summary is not an extensive overview of the invention. It is intended to neither identify key or critical elements of the invention nor delineate the scope of the invention. Its sole purpose is to present some concepts of the invention in a simplified form as a prelude to the more detailed description that is presented later.

The present invention provides methods and apparatus, including computer program products, for mobile electronic networked billboards.

In general, in one aspect, the invention features a method enabling a computing device, carried by a human, with a screen that displays one or more advertisements, connected via wireless and physical networks to a network of interconnected computers, populating a repository with a plurality of information about the advertisements, including but not limited to the ad type, the id of the specific ad, location of where each ad was displayed, the time and date each ad was displayed, photograph of viewers taken by the computing device each time the ad was displayed, the id of the human carrying the computing device, beacons detected (cellular devices around the carrier) when each ad was displayed, the time duration that each ad was displayed, the pay for each carrier based on their location when the ad was displayed, and the number of human impressions each time the ad was displayed. This plurality of information is stored on a storage device and retrieved by a computing device to provide information for owners and other interested third-parties of the advertisements to view performance of their ads, including but not limited to the number of times their ads were displayed on the computing devices described above, the location of where the ads were displayed, and the number of people who viewed the ads.

In addition, the invention also features a method by which advertisers can use a computing device, connected via wireless and physical networks to a network of interconnected computers, to send ads to the above described computing devices with screens carried by humans in order to add and modify the ads being displayed. Furthermore, the invention also features a method by which these ads can be placed by owners and interested third-parties to specific locations.

Other features and advantages of the invention are apparent from the following description, and from the claims.

### BRIEF DESCRIPTION OF THE DRAWINGS

The invention will be more fully understood by reference to the detailed description, in conjunction with the following figures, wherein:

FIG. 1 shows a functional block diagram illustrating one embodiment of an environment for practicing the invention.

FIG. 2 is a block diagram of the NOMAD server

FIG. 3 is a block diagram of the human-carried client computer with display

FIG. 4 is a flow diagram (Human-carried electronic networked billboard display and tracking)

FIG. 5 is a flow diagram (Active zone composition)

FIG. 6 is a flow diagram (File display management)

FIG. 7 is a flow diagram (Reports and statistics)

### DETAILED DESCRIPTION

The subject innovation is now described with reference to the drawings, wherein like reference numerals are used to refer to so like elements throughout. In the following description, for purposes of explanation, numerous specific details are set forth in order to provide a thorough understanding of the present invention. It could be evident, however, that the current invention could be practiced without these specific details. In other instances, existing and known structures and devices are shown in block diagram form in order to facilitate describing the present invention.

As used in this application, the terms “system,” “component,” “platform,” and the like can refer to a computer-related entity or an entity related to an working machine with one or more specific functionalities and processes. The entities disclosed herein can be either a combination of hardware and software, hardware, software, or software in execution. For example, a component may be, but is not limited to being, a process running on an object, a processor, an executable, a thread of execution, a program, and/or a computer. By way of illustration and explanation, both an application running on a server and the server can be a component. One or more components can reside within a process and/or thread of execution and a component may be localized on one computer and/or distributed between two, three or more computers. Also, these components can execute from various computer readable media having various data structures stored thereon. The components can communicate via local and/or remote processes such as in accordance with a signal having one or more data packets (e.g., data from one component interacting with another component in a distributed system, local system, and/or across a network such as the Internet with other systems via the signal).

In addition, the term “or” is intended to mean an inclusive “or” rather than an exclusive “or.” That is, or clear from context, “X employs A or B” is intended to mean any natural inclusive permutations. That is, if X employs A; X employs B; or X employs both A and B, then “X employs A or B” is satisfied under any of the foregoing instances. Moreover, articles “a” and “an” as used in the subject specification and annexed drawings should generally be construed to mean “one or more” unless specified otherwise or clear from context to be directed to a singular form.

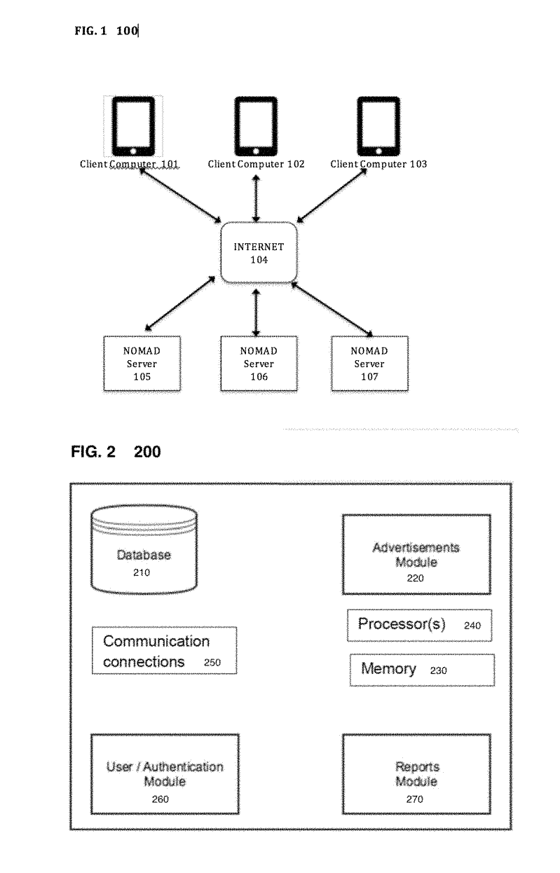

As shown in FIG. 1, an exemplary network 100 includes a number of client computers 102, 103, and 104, linked to one or more NOMAD servers 105, 106, and 107 through a group of interconnected computers, e.g., the Internet, 104. Example client computers include personal computers (PCs), tablets PCs, smartwatch, netbook computers, televisions, laptop computers, smartphones, and so forth.

As shown in FIG. 2, the NOMAD server 200 includes one or more databases 210, advertisements modules 220, memory 230, processors 240, communications connections 250, user/authentication module 260 and reports module 270. The memory 230 includes an operating system (OS), and a display and reporting process 400, fully described below. One role of the database 210 is to store files uploaded from customers that can include graphics, audio, video, audio/video, marketing materials, data sheets, press releases, infographics, and poster files, and so forth;

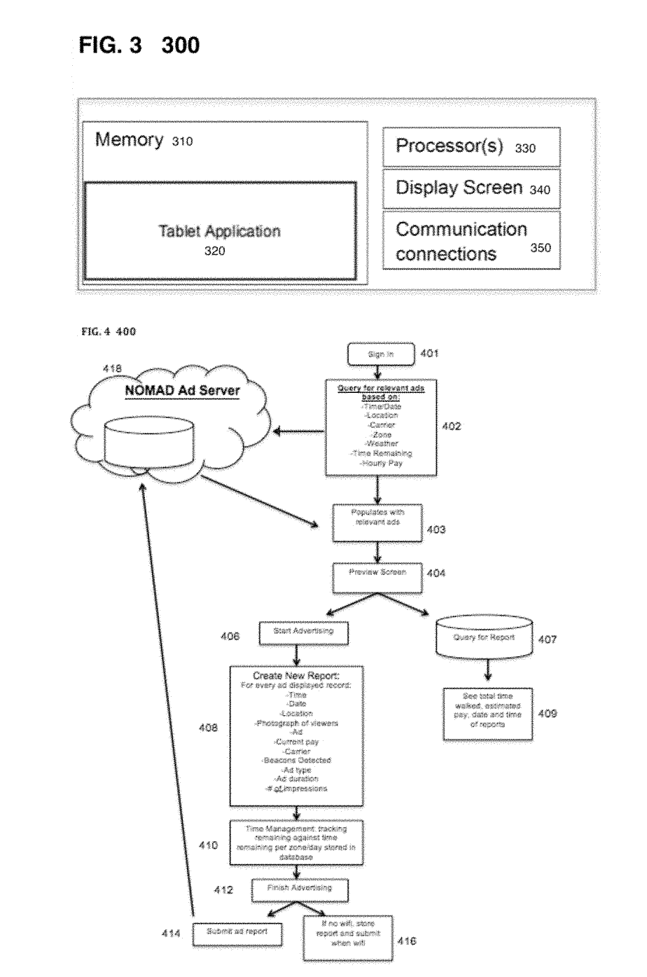

As shown in FIG. 3, the NOMAD client computer 300 includes a processor 330, a memory 310, Processors 330, one or more display screens 340, and communications connections 350. The memory 310 includes an operating system (OS) such as Windows®, Android®, Linux® or iOS®, and a NOMAD process 400, fully described below. The memory 310 stores files uploaded via communication connections 350 from one or more of the NOMAD servers 105,106, 107 and can include graphics, audio, video, audio/video, marketing materials, data sheets, press releases, infographics, and poster files, and so forth; These files are presented on one ore more display screens 340.

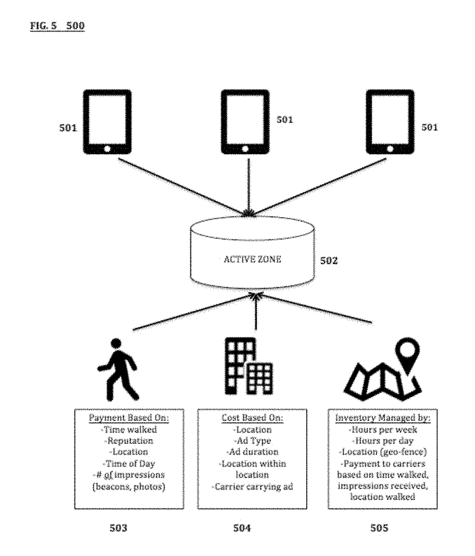

As shown in FIG. 4, one embodiment of this technology includes a process for Human-carried electronic networked billboard display and tracking of the files displayed. Process 400 includes a user sign in 401 which links the user session to their specific nomad network identity, which includes but is not limited to their name and zone. When a user first registers with the nomad server 418, the registration process requires the registrant to be assigned to a geographical identifier area or zone. This initial zone assignment to one area enables the human-carrier electronic billboard display network to retrieve content from the nomad server 418 based on, but not limited to, the following criteria; time/date, location, carrier, zone, weather, time remaining, hourly pay 402.

Process 400 populates 403 the client computer/preview screen 404 with relevant ad content based on the defined/applicable parameters and variables 402. These populated ads enable a user to view what content will be playing. In addition, a user may view customized notes, comments, and messages that are populated with each ad in the preview screen 404.

From the preview screen 404, a user may select to start advertising 406. By selecting start advertising, the client computer begins displaying the relevant content that was downloaded by the nomad server 418,403. This content could come in the form of photos, video files, animation, or any other file format that may be electronically displayed on a display attached to a client computer. In the preferred embodiment, the user would have the client computer and display connected to a backpack, but in alternate embodiments it could be a hat, knee pads, a pocket protector.

Once start advertising is selected and the user begins walking through three-dimensional space with their client computer and display, a new report is created 408 which includes a record of the following items for every ad that is played; time, date, location, photograph of viewers, ad type, ad duration, and the number of impressions, current pay, beacons detected, and carrier. As the user continues an advertising session, the report is consistently updated with information until the session is ended. As the user advertises, the time management system 410 continuously tracks the user's reports 408 against the daily hours remaining for the zone which is stored in the nomad database 418. While connected to a wifi or cellular network, the time management system 410 consistently transmits and receives data for accurate time and inventory measurements. An advertising session concludes when the user selects Finish Advertising 412 at which point the carrier report 408 marks the end time of the session and concludes.

The nomad server 418 and nomad process 400 is not a one-to-one relationship but enables a one-to-many and a many-to-one relationship. For example, a customer can upload content, such as ads, to the database 418. Once uploaded, the ad content is available to other users that match the relevant criteria. Relevant users with interest in completing the advertising task are notified of the newly uploaded content by the nomad process 400. The notification can be via an activity status update, a dashboard notification, an individual or daily notification email, a text message, a mobile device notification with an invitation as to whether any other user wants to accept or deny this activity or opportunity. If a user is interested in the opportunity, the user may sign in 401 and continue with the nomad Human-carried electronic networked billboard display and tracking process 400.

In some instances, a user will be connected to a wireless or cellular network. If connected, the completed report 408 is uploaded and submitted 414 to the nomad server 418 for processing. In some instances, a user will not be connected to a wireless or cellular network. If no connection is present, the report 408 is stored 416 on the device and uploads to the server 418 at the next opportunity sufficient wifi or cellular connection becomes available.

In some instances, a user may wish to view their past carrier reports. A user can view their past performance/carrier reports by selecting the carrier report tab from the preview screen 404. Upon selection, the application queries for past reports for the particular user and displays them in an ordered array that allows a user to easily view their time walked, estimated pay, date and time of reports. In some examples, user data may be represented through data

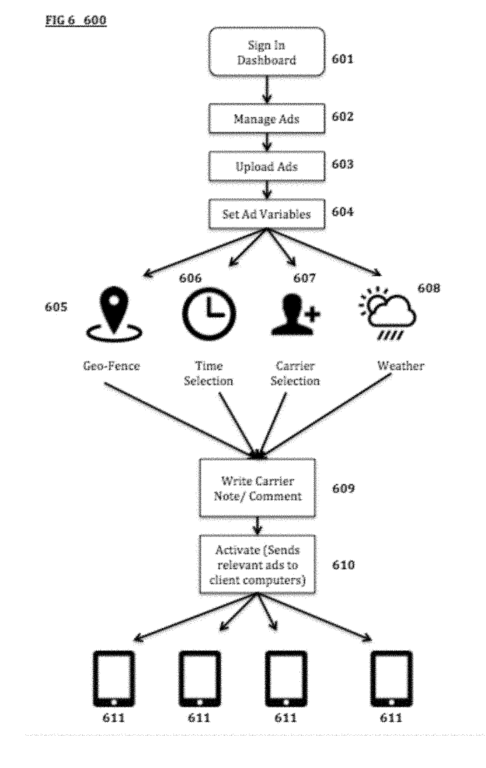

As shown in FIG. 5, one embodiment of this technology includes a system within which zones are created, organized, and defined. Hereby referred to as the “active zone composition” system 500, the system features multiple nomad servers 501 connected via the network to one main, central active zone server 502. In some instances, the active zone composition receives inputs from user-defined variables and acts as an aggregator of the different variables. As shown in FIG. 5, the system 500, is receiving variable inputs from (but is not limited to) the following three sources; carrier 503, customer 504, and inventory 505.

Within each criteria section are several different variables that may define a zone. In this example, the carrier module 503 is defined by, but not limited to, the following variables; carrier time walked, reputation (social and within nomad), location, time of day, number of impressions which may be measured by faces in photo or beacon detection methods 503. In this example, the customer module 504 is defined by but not limited to the following variables; location ads are displayed, ad type, ad duration, location within the location, and the carrier carrying the ad 504. In this example, the inventory management module 505 is defined by, but not limited to, the following variables; broadcast hours available per week, broadcast hours available per day, location (geo-fence), payment to the carrier based on time walked, impressions received, or locations 505.

By aggregating distinct variables from the different modules 503, 504, 505, a active zone 502 becomes a unique ecosystem that houses relevant ad, carrier, business, and inventory parameters. In some instances, user carrier computers 501 may be assigned to this zone and therefore be linked via network to the relevant ad, carrier, payment, location, and inventory content.

The active zone composition system 500 is not a fixed system. User computers 501 may enter and exit the zone assignment 502 based on the defined variables 503, 504, 505 that the user matches with. Similarly, the defined variable modules 503, 504, 505 and their corresponding content may change to create real-time zone 502 modifications. This example of a flexible, open system allows for user computers 501 to consistently be given the most relevant content that they match with.

The active zone composition system 500 is not meant to be a single or standalone system. The diagram depicted in FIG. 5 is to be accompanied by multiple other systems of similar organization to create multiple, unique zones with which user computers 501 may match with based on relevant variables 503, 504, 505.

As shown in FIG. 6, one embodiment of this technology includes a process for file display management 600. The file display management process 600 allows for a sophisticated user to manage the content that is displayed on nomad client computers.

In one embodiment, the user will sign in to the nomad dashboard 601 which will represent a customer portal with access to multiple different elements of the customer experience.

In one example, a sophisticated user will select the manage ads 602 tab from the dashboard screen. By way of example and not limitation, the user would then upload files 603 into the manage ads screen, uploading any file that may be compatible with the client computer device.

Once the desired files are uploaded 603, the user would then have access to a content library which houses all previously uploaded files since the inception of the user's account. From the library, a user may then set ad variables for a specific file/ad 604. Setting ad variables require a user to define several different parameters for the ad. The variables include but are not limited to geo fence/location 605, time selection 606, carrier selection 607, and weather 608. Each of the variable modules listed above contains separate parameters that must be defined for each ad. When defining geo-fence/location 605, a sophisticated user has the ability to fence a specific area within a zone. Using the geo-fence tool, the user draws a parameter around the area he/she wishes to target. Once selected, the latitude and longitude coordinates of the selected area will be tied to the specific ad for which the fence was set. When defining the time selection 606 of an ad, the user uses the clock/time tool to designate when they would like the specified ad displayed. Once selected, the time parameters for that ad are applied. When defining the carriers that will display the particular ad 607, the user will select from an array of carrier profiles and activate desired carriers based on but not limited to the following criteria; brand match, reputation, cost, visibility, location, route history, nomad rating. Once selected, the desired carriers will be tied to the specific ad. When defining the weather selection for an ad 608, a user can set parameters around which weather conditions will correspond to certain ads. For example, a user may define that an ad for hot coffee only shows when the temperature drops below 50 degrees but an ad for ice cream only shows when there is less than 20% cloud cover.

After defining, selecting, and activating the various variable sets, the user may proceed to write a custom note/comment 609 to go along with the particular ad. This comment may come in the form of a direct message, notification, text message, email, or other means of electronic communication and is meant to be a direct line of communication from advertiser to client computer user (carrier).

With all parameters set 605, 606, 607, 608 and comments inputted 609, the user activates the desired ad, an action that distributes the ad (via nomad server) to all relevant carriers that meet the current variable parameters as defined in the active zone composition system FIG. 5.

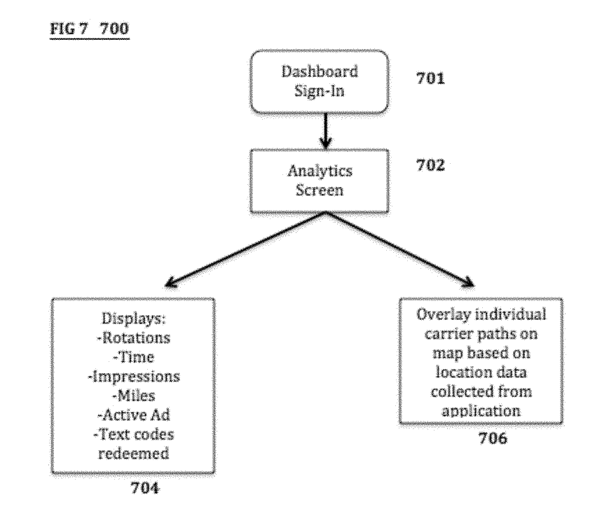

As shown in FIG. 7, one embodiment of this technology includes a process for accessing and viewing customer reports and statistics. The process, which includes but is not limited, an analytics screen with graphical and visual representations of data obtained from content display on the human attached electronic billboard system.

In one embodiment, a user signs in to the customer portal/dashboard 701 and navigates to an analytics screen 702. The analytics screen may appear in multiple placements across the portal, including but not limited to display for all-up analytics on the home screen, region specific analytics, and zone specific analytics. A similar analytics screen may appear for client computer users who wish to visually analyze carrier report data. In one example, the analytics screen 702 will consist of a blank canvas within which a user may build customized widget arrangements for the analytic components they find useful and necessary to their campaign.

In any of the numerous embodiments of the analytics screen 702, core statistics are displayed and presented to the user. These statistics 704 include but are not limited to rotations, time, impressions, miles, active ad, text codes redeemed. The statistics presented are to be presented to the user based on a rule of relevancy. For example, if a user is in a zone-specific view and adjusts their time constraints to view only one day's worth of analytics, the corresponding data and statistics that are presented are relevant to the variables as defined by the user.

In addition to key statistics, embodiments of the analytics screen may show a geographical representation of where the users ads were displayed within an area. Again following the rule of relevancy, a user can view heat maps and individual paths of the routes carriers took while displaying their ads. The location data, relayed via the network from the client application, plots walk paths on an API map feature and allows for a user to see where their content was played. This feature, which may be combined to show impressions, photos, weather, text redemption, or other patterns will be tied to the specific zone a user is requesting to view and the time window specified by the user. In one example, the client application would take photos out of the device while in session and those photos would be plotted on the user map to create a visual, live tour of the zone environment.

Various implementations of the systems and techniques described here can be realized in integrated circuitry, specially designed ASICs (application specific integrated circuits), digital electronic circuitry, computer hardware, firmware, software, and/or combinations thereof. These various implementations can include implementation in one or more computer programs that can be executable and/or interpretable on a programmable system including at least one programmable processor, which may be special or be of general purpose, coupled to receive data and instructions from, and to transmit data and instructions to, a storage system, at least one input device, and at least one output device.

These computer programs (also known as software applications, programs, software or code) include machine instructions for a programmable processor, and can be implemented in a high-level procedural and/or object-oriented programming language, and/or in assembly/machine language. As used herein, the terms “computer-readable medium” and “machine-readable medium” refers to any computer program product, apparatus and/or device (e.g., magnetic discs, memory, optical disks, Programmable Logic Devices (PLDs)) used to provide machine instructions and/or data to a programmable processor, including a machine-readable medium that may receive machine instructions as a machine-readable signal. The term “machine-readable signal” refers to signals used to provide machine instructions and/or data to a programmable processor.

To provide for interaction with a user, the systems and techniques described here can be implemented on a computer having a display device (e.g., a CRT (cathode ray tube) or LCD (liquid crystal display) monitor) for displaying information to the user and a keyboard and a pointing device (e.g., a mouse or a trackball) or vision tracking device by which the user can provide input to the computer. Other kinds of devices can be used to provide for interaction with a user as well; for example, feedback provided to the user or userers can be any form of sensory feedback (e.g., visual feedback, auditory feedback, or tactile feedback), and input from the user can be received in any form, including acoustic, speech, or tactile input.

The systems and techniques described here can be implemented in a computing system that includes a middleware component (e.g., an application server), or that includes a back-end component (e.g., a data server), or that includes a front-end component (e.g., a client computer having a graphical user interface or a web browser through which a user can interact with an implementation of the systems and techniques described here), or any combination of such back-end, middleware, or front-end components. The components of the system can be interconnected by any form or medium of digital data communication (e.g., a communication network). Examples of communication networks include a local area network (“LAN”), a wide area network (“WAN”), and the Internet.

The computing system can include servers and clients. A client and server are generally remote from each other and typically interact through a communication network, such as the Internet. The relationship of client and server arises by virtue of computer programs running on the respective computers and having a networked client-server relationship to each other.

The foregoing description does not represent an exhaustive or full list of all possible implementations consistent with this disclosure or of all possible variations of the implementations described. A number of possible implementations have been described. Nevertheless, it will be understood that various modifications may be made without departing from the spirit, approach and scope of the systems, devices, methods and techniques described here. For example, various forms of the flows shown above can and may be used, with steps re-ordered, added, or removed. Accordingly, other implementations are within the scope of the following claims.

What is claimed is:

1. A method comprising:
in a client computer with one or more electronic displays, connected to one or more servers residing in a network of interconnected computers, is attached to a mobile human navigating in three-dimensional space in a fashion that enables other humans to view the electronic displays;
retrieves computer files from the servers for the presentation of at least one file on the electronic displays;
storing reports on the client computer and servers information about each time the file is presented on the human-attached electronic displays, and all relevant information associated with the display of the file;
generating statistics and reports based on the information collected for each time the file is presented on the electronic displays;

2. The method of claim 1 wherein the electronic display can be attached to any part of a human being.

3. The method of claim 1 wherein the electronic display can be any size that can be attached to a human being.

4. The method of claim 1 wherein the computer file presented on the electronic display is selected from a group consisting of but not limited to graphics, audio, video, audio/video, marketing materials, data sheets, press releases, infographics, and poster files.

5. The method of claim 1 wherein the computer file presented on the electronic display is selected based on data retrieved from external sources consisting of one or more of the following: location of the client computer displaying the file, identification of human carrying the client computer displaying the file, weather information, time of day, date, <inventory> and identification of humans viewing the electronic display on the client computer.

6. The method of claim 1 wherein the information associated with each time the computer file is presented includes the name and identification number of the presented file, the time and date the file is displayed, photographs of viewers taken by the client computer each time the file is displayed, the name of the human carrying the client computer, the identification numbers for each beacons detected when the file is displayed, the time duration that the file is displayed, the pay for each human carrying the client computer based on their location where the file is displayed, and the number of human who viewed the file each time the file is displayed.

7. The method of claim 6 furthering comprising:
generating a report based on the collection of information about each file displayed from one or more human carrying each file;

8. The method of claim 7 wherein the report comprises statistics.

9. The method of claim 8 wherein the statistics comprise the names of each human who carried the file, the number of times the file was displayed, the number of views of the file by surrounding humans, the images of each human who viewed the file, the number of miles the file was transported, the location for each display of the file, the time and date each time the file was displayed, the identification of all beacons detected while the file was transported, and the amount of time each time the file was displayed.

10. The method of claim 9 further comprising a graphical illustration with lines, heat maps, or charts of the path one human walked displaying the file, and the paths multiple humans walked displaying the files.
